(19) United States
(12) Patent Application Publication
(10) Pub. No.: US 2026/0051740 A1
(43) Pub. Date: Feb. 19, 2026

(54) METHOD FOR OPERATING AN ELECTROLYSIS SYSTEM

(71) Applicant: Siemens Energy Global GmbH & Co. KG, München (DE)

(72) Inventors: Sven Schumann, Wilhermsdorf (DE); Andreas Bartmann, Erlangen (DE)

(21) Appl. No.: 19/102,908

(22) PCT Filed: Aug. 9, 2023
(86) PCT No.: PCT/EP2023/072032

§ 371 Date: Feb. 11, 2025

(30) Foreign Application Priority Data
Aug. 18, 2022 (DE) 10 2022 208 558.2

(51) Int. Cl. H02J 3/28; C25B 1/04; C25B 9/65; C25B 15/02

(52) U.S. Cl. CPC H02J 3/28; C25B 1/04; C25B 9/65; C25B 15/02

(57) ABSTRACT

The invention relates to a method for controlling an electrolysis plant with auxiliary systems and an electrolysis unit and a connection to an unreliable electricity source. For this purpose, firstly a starting condition is defined, which for the change from an idle state to a standby state requires prediction that there will be a sufficient power initially for operation of the auxiliary systems and subsequently over a longer period of time for operation of the electrolysis unit. The starting of electrolysis by way of changing to an operating state is triggered by an operating condition with an operating condition, for which a sufficient period of time with sufficient power is likewise predicted.

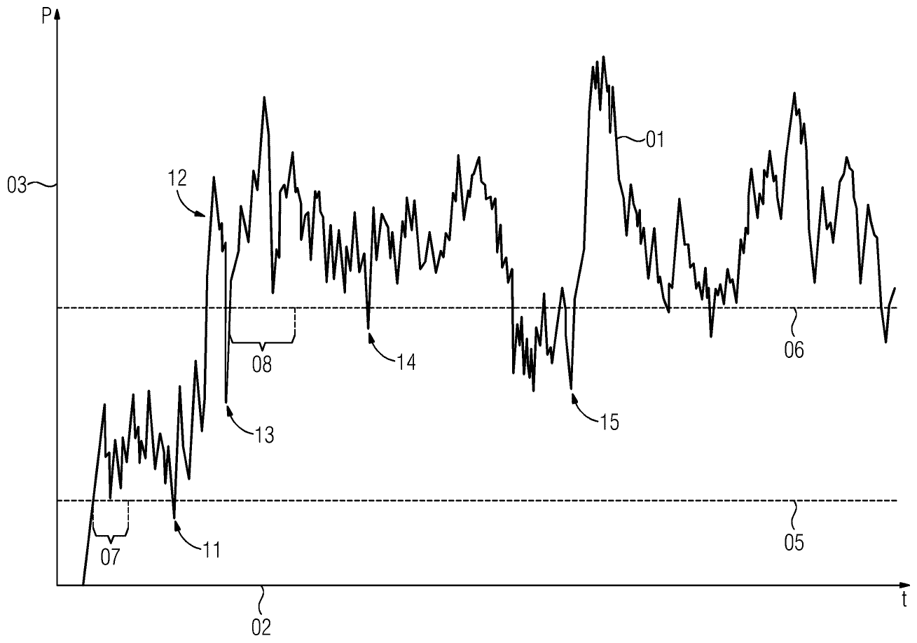

### TECHNICAL FIELD

The invention relates to a method for operating an electrolysis plant. Auxiliary systems and an electrolysis unit are needed to carry out the method. Furthermore, the method takes account of the fact that the energy available to the electrolysis plant is obtained from an electricity source which provides a power of varying magnitude at irregular intervals.

### BACKGROUND TO THE INVENTION

The auxiliary systems and the electrolysis unit each require a specific design-dependent time period in order to change from the switched-off state to the respective switched-on state with constant operation. In this case, the auxiliary systems need to be started before the electrolysis unit is started. Afterward, provided that enough power is made available, the electrolysis unit is started.

It is known that renewable energies (sun, wind, etc.) are often available at locations at which the demand is however very low. This results in the necessity of taking the energy from the location where it is obtained to the location with the demand for energy. In this context, in many cases renewable energy is obtained in the form of electricity, for example by way of solar parks or by way of wind power installations. If a large distance between generation and consumption needs to be bridged, then it is appropriate to use the renewably obtained electricity to generate storable and more easily transportable hydrogen by means of electrolysis. The non-constant power made available by the electricity source is disadvantageous here.

Therefore, in known methods for operating an electrolysis plant, the expected power from the electricity source is constantly determined.

If, for a sufficient time period, the power exceeds the power required for the auxiliary systems, the latter are generally started up. This is based on the assumption that the electricity is available as it were “at no cost” or without otherwise being used.

If, with the auxiliary systems having been switched on, energy is furthermore sufficiently available for operation of the electrolysis unit, the latter is generally likewise immediately switched on. Here, too, an attempt is made to use the renewably generated electricity as promptly as possible for electrolysis.

### SUMMARY OF THE INVENTION

Even though the known procedure makes it possible to achieve a high yield of hydrogen using the renewably generated electricity, it has been found, however, that the mode of operation results in more rapid aging of the electrolysis unit. In this case, maximum hydrogen production is not always advantageous vis-à-vis the costs for operation and maintenance of the electrolysis plant.

The problem addressed by the present invention is therefore that of enabling optimum hydrogen production while weighing the costs for operation and maintenance of the electrolysis plant.

The problem addressed is solved by a method according to the invention in accordance with the teaching of claim 1. The dependent claims relate to advantageous method procedures.

Firstly, an electrolysis plant is required. This comprises at least one electrolysis unit as an essential element. The type of design and the fundamental mode of operation of said electrolysis unit are initially unimportant. At the very least, the electrolysis unit is provided for enabling hydrogen to be produced with the aid of an electricity feed.

Furthermore, operation necessitates auxiliary systems, the operation of which is a prerequisite for operation of the electrolysis unit. The type of auxiliary systems is likewise initially unimportant. Here, too, a person skilled in the art may resort to known electrolysis plants with the auxiliary systems used therein. The auxiliary systems may comprise controllers, pumps, cooling units and filter equipment, for example. The auxiliary systems specifically required depend on the design of the electrolysis unit, inter alia. They are absolutely necessary for the application of the method according to the invention, but their exact embodiment is unimportant, provided that their performance data are taken into account. In this respect, a person skilled in the art may resort to known embodiments of electrolysis plants with electrolysis units and auxiliary systems. In this respect, this does not need further explanation.

An electricity source is furthermore required, the energy required for operation of the electrolysis plant being fed from said electricity source. The electricity source within the meaning of the present invention relates to the connection to an electricity generating installation such as, for example, a solar park or a wind power installation (rather than to the electricity generating installation as such). It should be taken into consideration here for the method that the supply power made available by the electricity source of the electrolysis plant may have a fluctuating unreliable progression. Irrespective of that, it is likewise possible to use the method even if the electricity source reliably and permanently provides an advantageously usable power. In this respect, the supply power may (but need not) fluctuate both in magnitude and in duration or fall completely to zero, or the method needs to reckon with the fact that the supply power is not constant.

Proceeding from the fact (without this fact being a prerequisite for the method) that the electrolysis plant is used at locations which are used at a distance from a regular electricity grid, a reserve unit is required to be available. This reserve unit must be able to make it possible for the electrolysis plant to be shut down in a controlled manner in the event of outage of an electricity supply by the electricity source. The type of reserve unit is initially unimportant. At the very least, the auxiliary power must be available immediately for delivery during operation of the electrolysis unit, in order to make immediate shutdown possible in the case of a decrease or outage of the supply power. The reserve unit obviously needs to be able to supply the auxiliary power required during shutdown over the time period until the electrolysis plant is switched off.

Proceeding from relevant units of the electrolysis plant, the electrolysis unit and the auxiliary systems, various states arise.

A distinction is drawn here between an idle state, in which both the electrolysis unit and the essential auxiliary systems are switched off. Independently of that, provision can be made for individual auxiliary systems which have a low power to be operated. At the very least, in this state it is not possible for electrolysis to start and the energy consumption is reduced to zero or to a very low level.

The standby state is characterized in that it is possible for the electrolysis unit to be started virtually at any time. For this purpose, it is necessary that the required auxiliary systems have been started up beforehand. Operation of the auxiliary systems has the consequence that power is drawn for their operation without electrolysis taking place.

In the operating state, the electrolysis unit is supplied with operating current and hydrogen is produced by means of electrolysis.

It is generally not possible for an electrolysis plant to be started immediately so that hydrogen production promptly takes place. Rather, switch-on processes require a certain period of time before the electrolysis unit can be started and hydrogen production can take place. Various measures are required depending on the state of the electrolysis plant when the latter is intended to resume operation.

Before electrolysis starts and thus before the operating state is attained, various auxiliary systems need to be switched on. It should be taken into consideration here that the various auxiliary systems which need to be ready for operation before actual electrolysis starts each require an individually specific time period. This time period may be influenced to a certain extent by the design of the auxiliary systems, but is greatly dependent on the design of the electrolysis unit and the mode of operation thereof. This results in a start-up time period which is specific to the electrolysis plant and which is required for changing from a switched-off electrolysis plant in the idle state to the standby state, in which the electrolysis unit can be started at any time.

It should be assumed that the start-up time period is at least a number of minutes. On the other hand, the start-up time period is intended to be not more than 4 hours.

Equally, when actual electrolysis has ended, operation of auxiliary systems continues to be necessary. In particular, it is often necessary to ensure that the electrolysis unit can cool down in a controlled manner. In this respect, there is a switch-off time period in which auxiliary systems must continue to be in operation after electrolysis has ended. This time period, too, may be influenced by the design of the auxiliary systems, but is still greatly dependent on the design of the electrolysis unit and the mode of operation thereof.

It should be assumed that the switch-off time period is at least a number of minutes. On the other hand, the switch-off time period is intended to be not more than 4 hours.

The various auxiliary systems have an individually specific constant or state-dependent power depending on the operating state. What is relevant to the consideration is the required power of the auxiliary systems in total for changing from the idle state to the standby state. The standby state can be attained only if this specific auxiliary power of the auxiliary systems can be made available. This analogously applies to the auxiliary power of the auxiliary systems in total for changing from the operating state to the idle state.

Irrespective of that, it may be provided that depending on the operating state, individual auxiliary systems at times are switched off or have their power reduced, while other auxiliary systems continue to be operated without reduction. Provided that it is possible virtually at any time to start electrolysis and thus switch to the operating state, this is regarded as the standby state. This is considered still to exist provided that the time period until the electrolysis unit possibly starts is a maximum of 0.1 times the start-up time period. By way of example, the power of pumps could be reduced, which by contrast are ramped up very rapidly again to the envisaged power for the start of electrolysis.

After the electrolysis unit has started, some time elapses until the produced hydrogen can also be effectively transferred away from the electrolysis plant. In particular, a certain period of time is needed to attain a substantially steady-state operating temperature and to build up an advantageous pressure in the plant. Furthermore, the circulation of water and the process of separating oxygen and hydrogen require some time to attain a substantially steady state (proceeding from a constant electricity feed). Furthermore, this starting process Causes an energy consumption without appreciable hydrogen production. The duration is dependent here firstly on the design of the electrolysis plant and secondly on the design of the electrolysis unit and the mode of operation thereof.

This results in the definition of a minimum operating duration taken to attain a substantially steady state (assuming a constant power feed).

Furthermore, the minimum operating duration requires a ratio between the amount of hydrogen obtained and the energy introduced for the minimum operating duration to be at least 50% of that amount which is obtained during ongoing operation with the same energy use. In other words, at least the amount of hydrogen which is produced during ongoing operation with half the energy use has been produced at the end of the minimum operating duration.

Particularly advantageously, the operating duration requires the ratio of hydrogen obtained to energy use at the end of the minimum operating duration to correspond to at least 0.8 times the ratio during ongoing operation.

It should be assumed that the minimum operating duration is at least 15 minutes. On the other hand, the minimum operating duration is intended to be not more than 4 hours.

Electrolysis obviously requires a power feed. In order to ensure a stable process with economically viable hydrogen production, the power feed must not fall below a certain lower limit. Taking into consideration the power required here for the auxiliary systems, in total this results in a minimum power which must be available for operation of the electrolysis plant in the operating state.

Depending on the design of the electrolysis unit and the mode of operation thereof, there is a working range in which the electrolysis unit can be operated with a higher power with a greater yield of hydrogen. This range is limited by a maximum power as of which no increase in hydrogen production can be achieved and/or damage to the electrolysis plant may occur.

The method according to the invention firstly requires a starting condition to be defined. The idle state of the electrolysis plant is assumed here. It is firstly necessary for the supply power to be above the auxiliary power at least for the time period of the start-up time period. Since the supply power is not unambiguously defined in the case of an unreliable electricity source, it is necessary to use a predicted supply power exhibiting probabilities.

The probability for the predicted power can be determined in various ways. Firstly, it is possible to have recourse to the probability provided for the available energy source, for example expected wind speed. Secondly, historical data can be taken as a basis for determining a probability between past predictions and the actual values. At the very least, a person skilled in the art is readily able to determine expedient values for the probability as a basis for making it possible to implement the method.

Since the predicted supply power ultimately contains a presumption, but an actual power has to be provided for starting up the auxiliary systems, the starting condition furthermore needs to stipulate that the predicted supply power is above the required auxiliary power with sufficient probability.

A sufficient probability is assumed to exist if the probability is above 80%. It is particularly advantageous if the stipulation for a sufficient probability is for the probability to be above 90%.

By contrast, if a high probability is at issue, then it is assumed that the probability is above 95%.

It should be pointed out that in the context of the question of probability, it should be taken into consideration that a check is made to establish whether limit values are exceeded. In other words, what is of interest is not the probability as to whether the supply power that actually occurs later corresponds to the previously predicted supply power. Rather, it is necessary to assess whether the supply power that actually occurs later exceeds the limit value considered in each case.

After the start-up time period with changing from the idle state to o the standby state, it is necessary that the predicted supply power can be expected to be further above the auxiliary power. It is initially unimportant here how long this time period lasts.

Furthermore, the presence of the starting condition requires the minimum power to be attained after the start-up time period or starting from a later point in time without an expected interim fall in the predicted power below the auxiliary power.

Firstly, the time period for which the predicted supply power can be expected to be above the minimum power is to be determined here.

Secondly, the probability that the predicted power will be above the minimum power is to be taken into consideration here.

Proceeding from these two considerations, the duration of the expected sufficient supply power and the probability of the sufficient level, the starting condition stipulates that that time period with a predicted supply power above the minimum power multiplied by the probability corresponds to at least 1.5 times the minimum operating duration. In other words, if it can be assumed with high probability that the predicted supply power is above the minimum power, then the required time period is somewhat more than 1.5 times the minimum operating duration. If the probability is only 50%, however, then the time period with the predicted supply power above the minimum power must already last for 3 times the minimum operating duration.

In other words, the starting condition assumes that as expected (since the supply power is only predicted and not precisely defined) after starting of the electrolysis plant with the switching on of the auxiliary systems, the latter can be operated without interruption until the electrolysis unit starts, and electrolysis can subsequently take place without interruption beyond the minimum operating duration.

Furthermore, it is necessary to define an operating condition. It is assumed in this case that the electrolysis plant is in the standby state, that is to say that the required auxiliary systems are in operation and, by contrast, the electrolysis unit is switched off. Here, by comparison with the starting condition, initially all that is required is for the predicted supply power to be above the minimum power for the minimum operating duration. However, a sufficient probability is required in this case.

In the course of checking with regard to the operating condition, the immediately succeeding time period is assessed as to whether the predicted supply power exceeds the minimum power. It should be assumed here that the probability is higher than the probability for the predicted supply power for the same time period when checking the starting conditions.

Here there is still the underlying assumption that if the auxiliary systems are already in operation anyway, it is beneficial if electrolysis can take place as expected for the minimum operating duration, particularly if the energy originates from renewable sources and cannot be expediently used in another way.

The electrolysis plant, with a defined starting condition and operating condition, is obviously used on the basis of the predicted supply power. If the electrolysis plant is in the idle state, the presence of the starting condition has the effect that switching to the standby state occurs and the auxiliary systems are started.

If the electrolysis plant is in the standby state and the operating conditions are met, this has the effect that switching to the operating state occurs and electrolysis is started.

By virtue of the novel method with delayed starting conditions, although renewable energies are not used as comprehensively as possible, this procedure prevents the electrolysis plant from starting if a sufficient time period for continuous operation of the electrolysis cannot foreseeably be expected. In this respect, the disadvantageous influencing of the electrolysis plant by changing switching-on and switching-off processes is reduced. As a result, the reliability and service life of the electrolysis plant can be improved, even though the hydrogen yield turns out to be a little lower. Taking into consideration the costs for the maintenance of the electrolysis plant, it should—but always depending on the actual supply power—thus be possible to produce hydrogen at lower costs.

For the design of the auxiliary systems and assuming that a longer time period with sufficient electricity supply by the unreliable electricity source can be expected for the starting of the electrolysis plant, it is not necessary to strive for a minimal start-up time period. Rather, it should be assumed that a start-up time period of less than half an hour causes an unnecessary additional complexity or additional costs for the auxiliary systems.

By contrast, however, the start-up time period should not be chosen to be unnecessarily long. This time period at any rate delays the possible starting of the electrolysis plant if it becomes apparent that a sufficient supply power for the start of electrolysis is subsequently present. In this respect, it is advantageous if the start-up time period is not more than 2 hours.

A lower limit value for the minimum operating duration is determined firstly from the proportion of produced hydrogen in relation to the energy use. Secondly, it is expected that a substantially stable process with virtually constant water flows has been established. A certain design latitude remains here, in which case the minimum operating duration may additionally also be chosen to be longer. Accordingly, it is advantageous if the minimum operating duration is at least half an hour, even though effective hydrogen production and stable processes may already be present previously.

In order to avoid an unnecessary delay in the starting of the electrolysis unit, care should be taken to ensure that the minimum operating duration is not more than 2 hours.

Depending on the possible linking of the electrolysis plant to a public grid, for example, or in contrast thereto the absence of said linking and depending on the required safety, the starting condition can be defined to stipulate that the predicted supply power is above the auxiliary power for at least the start-up time period with high probability.

Furthermore, it is obvious that the standby state requires a continued supply. Even though—as noted above—the required auxiliary power does not have a magnitude that is fixed for all periods of time, it is nevertheless necessary to provide the required auxiliary power (possibly fluctuating slightly over time) for the standby state.

Therefore, it is furthermore advantageous if the starting condition is required to stipulate that the required auxiliary power is also ensured for further operation over the standby state. In this case, what may be required in a simple manner is that the predicted supply power is above the auxiliary power for at least the start-up time period with sufficient or high probability. If an alternative or supplementary energy supply is possible, then this is advantageously also taken into consideration as replacement power.

Even if the prediction reveals that the predicted supply power is sufficient for changing from the idle state to the standby state and at a later point in time, without the predicted supply power falling below the required auxiliary power, the minimum power can be expected for a longer time period, unnecessarily long operation of f the auxiliary systems is nevertheless not optimal either.

Therefore, it is advantageous if the starting condition is concretized to the effect that between the attaining of the standby state with switched-on auxiliary systems and the expected starting of electrolysis, there is a time period of at most 3 times the start-up time period. In this respect, the starting of the electrolysis plant may be predicted to be temporally preceded by the attaining of the minimum power by advantageously not more than 4 times the start-up time period. Alternatively, the starting condition can be defined to stipulate that the predicted supply power attains the minimum power not later than after 3 times the start-up time period. In this case—as explained above—what should be required is that, in the case of the starting condition, it can be assumed that electrolysis can be carried out for the required duration.

The basic concept of the invention is to protect the electrolysis plant against unnecessary aging and hence premature maintenance, even if this means that renewable energy that is possibly available remains unused. Particularly under difficult spatial conditions for carrying out maintenance and supply with appropriate material and spare parts, it is advantageous if the longest possible service life or the longest possible service interval can be attained.

It is correspondingly advantageous here if the starting condition is tightened to the effect that after a start-up time period and continued electricity supply at the level of the auxiliary power until switching to the operating state, it is assumed that the predicted supply power, or the expected value thereof, enables continuous operation of the electrolysis unit for a longer time period than the minimum operating duration and accordingly as expected at least attains the minimum power for the time period. In this case, it is possible once again to take account of the probability for the predicted supply power.

Firstly, it is advantageous to establish the same requirement as in the case of the starting condition for the operating condition with regard to the required time period in which the predicted supply power is above the minimum power.

Furthermore, the operating condition is advantageously required to stipulate that that time period for which the predicted supply power is above the minimum power is multiplied by the probability and the product corresponds to at least 2 times the minimum operating duration. In other words, if it can be assumed with high probability that the predicted supply power is above the minimum power, then the required time period is somewhat more than 2 times the minimum operating duration. If the probability is only 50%, however, then the time period with the predicted supply power above the minimum power needs already to last for 4 times the minimum operating duration.

Furthermore, it is particularly advantageous if there is a requirement that the operating state can be predicted to be maintained at least for the time period, weighted with the probability, of 3 times the minimum operating duration.

The situation in respect of the starting conditions is analogously applied for defining the operating conditions, in which case here, too, the start of electrolysis is advantageously delayed in favor of a longer service life.

The reserve unit is required in order to enable the electrolysis plant to be shut down in a controlled manner in the case of an unexpected reduction of the supply power or the absence thereof. The means employed by the reserve unit to make this possible are initially unimportant.

The reserve unit may thus firstly be manifested as an electricity connection to a regular electricity grid. This embodiment is advantageous in particular at those locations at which, although an auxiliary power required for the auxiliary systems can be made available for shutting down the plant, the electricity connection is not able at all or appreciably to transfer away energy generated by the electricity source or to make energy amounting to the minimum power available to the electrolysis plant.

The use of the method according to the invention is appropriate particularly if a reliable electricity connection is not present. Under these prerequisites, in many cases it cannot be assumed that an electricity connection sufficient for a reserve unit can be ensured. In this respect, the use of a battery storage device is advantageously appropriate. Consequently, in an extreme case the electrolysis plant can be operated autonomously using renewable energy and a safe shutdown in the absence of the energy can be ensured.

If the reserve unit is a chargeable energy storage device, i.e. in particular a battery storage device, then the starting conditions are furthermore advantageously required to stipulate that after assumed operation of the electrolysis plant for the minimum operating duration in the operating state (predicted), in addition energy from the electricity source is sufficiently available in order to be able to sufficiently charge the energy storage device or the battery storage device. The sufficient state of charge of the energy storage device thus enables the safe shutdown in the absence of the energy at the energy source. This is obviously dependent on the respective state of charge of the energy storage device or battery storage device when the starting conditions are checked.

In the case of the embodiment of the reserve unit with a chargeable energy storage device, the state of charge and the probability of the arrival of the predicted supply power are advantageously taken into consideration with regard to the operating condition. If a high probability can be assumed for the predicted supply power, then it may be sufficient if the reserve unit is sufficiently charged at the end of the minimum operating duration.

If there is only a sufficient probability for predicted supply power (as is required for the starting condition), then what is advantageously required is that a sufficient state of charge of the reserve unit can already be attained at half the minimum operating duration.

The energy storage device or battery storage device can be charged during ongoing operation depending on the predicted supply power. If the latter is only slightly above the minimum power, it may be necessary for the energy storage device or battery storage device firstly to be charged before the starting of the electrolysis unit (since the predicted supply power is possibly not sufficient for delivering the minimum power to the electrolysis unit and at the same time charging the reserve unit). If the predicted power is sufficiently above the minimum power, it may likewise be provided that the electrolysis unit is started and changes to the operating state and at the same time the energy storage device or battery storage device is charged.

The reserve unit is necessary as a safeguard for a sudden outage of the supply power. By contrast, it may furthermore be advantageous to provide a storage device which can store the energy made available by the electricity source.

This makes it possible, in particular, that the energy that cannot be used by the auxiliary systems or in the electrolysis unit can be expediently stored for later use. The lengthened time periods owing to the definition of the starting conditions and the operating conditions almost inevitably go hand in hand with the capability to store energy made available by the electricity source before the presence of the starting conditions or before the presence of the operating conditions.

Since in principle a reserve unit is necessary and if a storage device is furthermore advantageously required, then these can be provided as separate units, in principle. In this case, the reserve unit is obviously operated differently than the storage device (storage in the reserve unit as a prerequisite for operation; storage in the storage device only in the event of an energy surplus).

The reserve unit is advantageously integrated in the storage device. In this respect, the storage device with integrated reserve unit is initially charged with higher priority in order to be able to ensure the safe shutdown of the electrolysis unit. The storage device is charged over and above that only in the case of an energy surplus or a supply power from the electricity source which is not consumed in the electrolysis unit nor by the auxiliary systems.

Furthermore, the presence of a storage device affords further possibilities for operation, such that the use of the electrolysis unit can continue to be operated without reduction particularly in the case of a charged storage device and momentary undershooting of the minimum power.

Assuming that it is particularly highly beneficial if momentary undershooting of the minimum power can be cushioned by the actual supply power, it is particularly advantageous if the charged storage device can supply at least half the minimum power for at least half the minimum operating duration. This enables further uninterrupted operation of the electrolysis unit, even if momentary fluctuations below the minimum power occur.

Furthermore, it is advantageous if the charged storage device can provide the minimum power. Consequently, the operating state can be maintained even in the event of a momentary complete decline in the supply power. In other words, the design of the storage device should therefore advantageously take account of the fact that the storage device can store energy which is required for operation of the auxiliary systems and the electrolysis unit.

In order to enable the electrolysis unit to be operated for as long as possible, it is furthermore provided that the charged storage device can provide at least more than half the minimum power for at least the minimum operating duration. Consequently, electrolysis can be continued even in the event of a longer drop in the actual supply power below the minimum power.

Since the electricity source is expected to be an unreliable electricity supply, it is necessary advantageously to define what measures should be implemented if the predicted supply power is lower than required for unchanged further operation of the electrolysis plant.

If the standby state has been attained or exists, then the question arises as to how long the predicted supply power will be below the required auxiliary power. This time period is defined as a permissible outage time period. Taking this as a basis, an outage condition is advantageously defined, the presence of which governs changing from the standby state to the idle state.

What is advantageously defined as a first condition is that an outage time period weighted with the probability is longer than X times the start-up time period. This is based on the assumption that, in the case of a relatively long time period, it is possible to effect switching firstly to the idle state and subsequently to the standby state again and in this case the auxiliary power can be saved in the interim. Consequently, the outage condition (as a trigger for the switching-off) is met if the time period until the renewed increase in the predicted supply power multiplied by the probability is longer than X times the start-up time period.

The question as to what is a particularly advantageous factor necessitates weighing up between unnecessary further operation of the auxiliary systems without electrolysis being able to take place promptly and a loss of time for shutting down the auxiliary systems and starting them up again. Limit values for the outage time period multiplied by the probability that are between 2 times and 10 times, for example 3 times or 5 times, the start-up time period have proved to be advantageous.

In this case, what should be taken into consideration particularly advantageously as a first condition is that the weighted outage time period is longer than 4 times the start-up time period. This enables a faster start in conjunction with an improvement in the prediction for renewed operation of the electrolysis unit, i.e. renewed presence of the operating condition. By contrast, if the deficiency exceeds a longer time period, then it is expedient to switch to the idle state (i.e. idle condition met).

Furthermore, it is only expedient to bridge an outage time period if a renewed start-up of electrolysis and hence hydrogen production can be expected to be possible after the outage time period. This advantageously yields the second condition for the outage condition. Accordingly, the outage condition is met if, after the outage time period, the operating condition predicted is not satisfied.

Further operation of the auxiliary systems in the event of deficient supply power is only possible if the missing energy is fed in another way. This is advantageously done by the storage device. However, this is obviously only possible if said storage device is charged sufficiently for this purpose. This yields the third condition for the outage condition. Accordingly, the outage condition is met if not enough energy for further operation of the auxiliary systems over the outage time period is stored in the storage device.

The presence of the storage device and the definition of an outage condition advantageously yield the method procedure that, when the outage condition is present, the auxiliary systems are shut down and this involves switching from the standby state to the idle state. Otherwise, the auxiliary power missing from the electricity source is provided by the storage device.

Furthermore, it should advantageously be considered what is the necessary procedure in the operating state, i.e. electrolysis taking place, if the actual supply power falls below the minimum power. If it is not possible for the missing power to be fed in another way, this directly leads to the necessity of switching to the standby state.

If a storage device of sufficient size is present, then this not only enables temporary operation of the auxiliary systems, but can also temporarily feed proportionally or completely the minimum power required for operation of the electrolysis unit.

As a result of this, it is furthermore advantageous if a stop condition is defined, the presence of which governs changing from the operating state to the standby state. The predicted supply power and the probability thereof should be analogously taken into consideration here. For this purpose, a deficiency time period is determined, wherein the stop condition is satisfied in the event of undershooting of the minimum power beyond the deficiency time period.

First of all, the stop condition should be assumed to be met if the operating conditions are not satisfied after the deficiency time period. In other words, the stop condition is met if, after the deficiency time period has elapsed, it is not possible to operate the electrolysis unit by supply from the electricity source for the minimum operating duration with sufficient probability.

Regarding the time period to be bridged, the deficiency time period is advantageously defined depending on the capacity and the state of charge of the storage device. Taking that as a basis, the deficiency time period should be limited to that time period in which the storage device is able to supply proportionally the minimum power missing from the electricity source or the absent minimum power.

In this case, however, the situation in which the storage device is fully drained in a planned manner should be avoided. In this respect, it is advantageous if the deficiency time period is limited as soon as the state of charge of the storage device falls below a limit value.

### Two Different Parameters Are Advantageously Conceivable

as a basis for the limit value. In a first variant, it is advantageous to relate a first limit value to the storage capacity of the storage device.

In a second variant, it may be advantageous to use a second limit value in relation to the respective state of charge of the storage device at the beginning of the deficiency time period.

Both in the first variant and in the second variant, these limit values are preferably between 5% and 25%. If, in the case of absent or deficient supply power of the electricity source, the missing minimum power is fed from the storage device over the deficiency time period, then at the end of the deficiency time period the state of charge of the storage device in absolute terms—first variant—or in relative terms—second variant—should not be below the associated limit value.

If the state of charge of the storage device before the deficiency time period is 50%, for example, then at the end of the deficiency time period the state of charge of the storage device should be not less than between 5% and 25%—first variant—or respectively not less than between 2.5% and 12.5%—second variant.

This obviously yields the method procedure according to which, if the deficiency condition is present, the electrolysis unit is switched off and changing from the operating state to the standby state takes place, while otherwise the missing minimum power is fed from the storage device.

The above explanations concerning the method according to the invention and concerning the advantageous method with the required electrolysis plant are independent of the number of electrolysis units, in principle. However, the indications concerning the starting condition, the operating condition and advantageously the stop condition and advantageously the outage condition relate to a first electrolysis unit.

Advantageously, the electrolysis plant comprises two or more electrolysis units. In this case, it is necessary to define the conditions for each of the individual electrolysis units. The conditions here may be identical or different, inter alia depending on whether the electrolysis plants are embodied identically or differently. For this purpose, it is also necessary to determine the associated time periods for each of the electrolysis units.

At the very least, if at least two electrolysis units are present, a method procedure is advantageous in which the electrolysis units are progressively switched on or off. Consequently, if the predicted supply power fluctuates, the available energy can be used more advantageously for hydrogen production.

### DESCRIPTION OF THE EMBODIMENTS

The following FIGURE illustrates by way of example a diagram for a possible progression for the supply power. By way of example, a supply power generated by a wind power installation may be involved, which is correspondingly provided at the electricity source for the electrolysis plant.

Here the supply power (P) 01—ordinate 03—is plotted against time (t)—abscissa 02. A lower limit line schematically depicts the required auxiliary power 05 of the auxiliary systems. Above that is a further limit line as minimum power 06 of the electrolysis unit together with the auxiliary systems.

It is assumed that a predicted supply power is involved and, by way of example, there is a probability of 80%.

In practice, obviously the probability will frequently depend on the time horizon, that is to say that the probability of the correctness of the predicted supply power usually decreases further and further as a time interval increases.

At the starting point the electrolysis plant is in the idle state. When the predicted supply power is determined, firstly the starting condition is checked.

Proceeding from the progression of the predicted supply power 01 illustrated by way of example, there is a time period over which the predicted supply power 01 is higher than the auxiliary power 05 and longer than the start-up time period 07 with sufficient probability.

By contrast, if there were a requirement for the predicted supply power 01 to be higher than the auxiliary power 05 with high probability and for there to be a probability of 80% here, then this condition would not be satisfied. However, the probability of a limit value being exceeded can be expected to be significantly higher than the probability of the predicted progression of the supply power.

In a succeeding time segment, there is a progression over which the predicted supply power 01 is above the minimum power 06. In this case, the factor of the time period with the exemplary predicted supply power 01 above the minimum power 06 multiplied by the exemplary probability of 80% is greater than 1.5 times the minimum operating duration 08.

As a result of this, the starting conditions are satisfied (at the beginning of the illustrated time segment 07) and the auxiliary systems should be started up, that is to say that changing from the idle state to the standby state takes place.

With auxiliary systems running in the standby state, a check is constantly made to establish whether the operating condition is satisfied. This is evidently the case since these were already present during the checking of the starting conditions for this exemplary progression.

With the advent of the operating conditions (at the beginning of the time period 08), changing from the standby state to the operating state takes place. That is to say that the electrolysis unit together with electrolysis is started.

It should be assumed that the progression of the predicted supply power changes over time depending on probability and in this case the probability increases with shorter distance into the future. When the starting conditions are present, it is assumed that the operating conditions will also happen at a later point in time. By contrast, what may readily occur is that the progression of the predicted supply power disadvantageously changes and the operating conditions are not attained as expected.

In the progression illustrated in exemplary fashion, some relevant points in time are illustrated by way of example for further elucidation. The fact of whether or not a storage device is present and the situation regarding the state of charge of the reserve unit and of the assumed storage device are of relevance here.

Firstly, in the standby state (following the start-up time period 07) there is a momentary drop below the auxiliary power—time segment 11. Without a storage device and if it is not possible or there is no desire to use the reserve unit as a replacement for bridging purposes, an immediate outage of the auxiliary systems (at least proportionally) would be the consequence (since, after all, the required power is missing).

However, a storage device is advantageously present, and SO firstly a check is made to establish whether the outage conditions are present. Assuming that the storage device is at least proportionally charged, it should readily be able to feed the missing auxiliary power. Moreover, the time period until the operating conditions are expected to be attained is short, and so the auxiliary systems do not have to be switched off, that is to say that the standby state is maintained.

In the further course of the progression, the supply power 01 rises above the minimum power—time segment 12. When the starting condition is checked, however, it may be ascertained that the predicted supply power is not above the minimum power 06 for the minimum operating duration—see time segment 13. Consequently, the standby state persists. The surplus energy above the auxiliary power is in this case advantageously fed to the storage device.

After the start of electrolysis, i.e. the minimum operating duration 08, there is a momentary drop below the minimum power—time segment 14. Likewise, as in the case of the time segment 11, this deficiency of energy can advantageously be provided from the storage device.

In the further course of the progression, the supply power 01 again falls below the minimum power 06—time segment 15. It should now advantageously be checked whether the stop conditions for switching off electrolysis have occurred. The deficiency time period extends from the dropping below the minimum power 06 to the renewed exceeding of the minimum power 06. It should be assumed that afterward the operating condition is satisfied again. The crucial question then is whether the storage device is able to feed the energy missing from the supply power up to the minimum power over the deficiency time period. If this is the case, then the operating state persists and electrolysis can be continued. By contrast, if the storage device is discharged, for example, then it is inevitably necessary to switch off the electrolysis unit and change to the standby state.

1. A method for controlling an electrolysis plant with an idle state and a standby state and an operating state comprising;
auxiliary systems which have in total a specific auxiliary power and are switched on in the standby state and in the operating state and have a specific start-up time period for changing from the idle state to the standby state and a specific switch-off time period for changing from the standby state to the idle state and are designed for a start-up time period of a maximum of 4 hours and a switch-off time period of a maximum of 4 hours;
at least one electrolysis unit which has a specific minimum power including the auxiliary power and in the operating state generates hydrogen and oxygen and has a defined minimum operating duration of between 0.25 hours and 4 hours;
at least one electricity source which supplies electricity at changing times and for changing time periods with changing supply power;
at least one storage device; and
at least one reserve unit integrated in the storage device and comprising a battery storage device;
wherein a sufficient charge of the battery storage device is provided if energy can be made available for delivering at least the auxiliary power over at least the switch-off time period;
wherein a determined probability is above 80% in a case of a sufficient probability and above 95% in the case of a high probability;
wherein proceeding from the idle state a starting condition is defined stipulating:
that a predicted supply power is above the auxiliary power for at least the start-up time period with sufficient probability;
that time period with a predicted supply power above the minimum power multiplied by its probability subsequently corresponds to at least 1.5 times the minimum operating duration, and
with sufficient probability the battery storage device can additionally be sufficiently charged by an end of the minimum operating duration;
wherein proceeding from the standby state an operating condition is defined stipulating that:
the predicted supply power is above the minimum power for the minimum operating duration with sufficient probability, and
the battery storage device can be sufficiently charged at the latest by the end of half the minimum operating duration with sufficient probability or at the latest by the end of the minimum operating duration with high probability;
wherein a prediction about an expected progression of a predicted supply power is made continuously proceeding from the supply power presently available;
wherein in the idle state presence of the starting condition brings about changing to the standby state;
wherein in the standby state the presence of the operating condition brings about changing to the operating state; and
wherein energy supplied by the electricity source and not consumed by the auxiliary system or the electrolysis unit is fed to the battery storage device.

2. The method as claimed in claim 1,
wherein the start-up time period is at least 0.5 hour and at most 2 hours; and/or
wherein the minimum operating duration is between 0.5 hour and 2 hours.

3. The method as claimed in claim 1,
wherein a starting condition is defined stipulating that:
the predicted supply power is above the auxiliary power for at least the start-up time period with high probability; and/or
the predicted supply power optionally supplemented by a replacement power, until beyond attaining of the minimum power, is above the auxiliary power with high probability; and/or
the attaining of the minimum power with a required duration by the predicted supply power is attained maximally after 4 times the start-up time period; and/or
that time period with a predicted supply power above the minimum power multiplied by a probability subsequently corresponds to at least 2.5 times the minimum operating duration.

4. The method as claimed in any of claim 1,
wherein an operating condition is defined stipulating that:
the predicted supply power is above the minimum power for the minimum operating duration with high probability and
the time period with a predicted supply power above the minimum power multiplied by the probability corresponds to at least 2 times the minimum operating duration.

5. The method as claimed in any of claim 1,
wherein a charged storage device can supply at least energy amounting to half the minimum power or the minimum power for at least half the minimum operating duration or the minimum operating duration.

6. The method as claimed in any of claim 1,
wherein proceeding from the standby state an outage condition is defined stipulating that the predicted supply power is lower than the auxiliary power for an outage time period,
wherein the outage time period weighted with the probability is longer than 3 times or 5 times the start-up time period, or
wherein the operating condition is not met after the outage time period, or
wherein the energy stored in the storage device is not sufficient for operation of the auxiliary systems over the outage time period; and
wherein under the outage condition the auxiliary system changes to the idle state and otherwise a missing auxiliary power is fed from the storage device.

7. The method as claimed in any of claim 1,
wherein proceeding from the operating state a stop condition is defined stipulating that the predicted supply power is lower than the minimum power for a deficiency time period,
wherein the operating condition is not met after the deficiency time period, or
wherein a permissible deficiency time period is defined by a supply capability of the storage device amounting to the minimum power limited to a lower limit value at the end of the deficiency time period of between 5% and 25% of a storage capacity and/or between 5% and 25% of the state of charge that existed before the deficiency time period;
wherein under the stop condition the electrolysis unit changes to the standby state and otherwise a missing minimum power is fed from the storage device.

8. The method as claimed in any of claim 1,
wherein the electrolysis plant comprises at least two or more electrolysis units, wherein the previous conditions relate to a first electrolysis unit and each further electrolysis unit has, assigned to the respective electrolysis unit, a starting condition and/or an operating condition and/or a stop condition and/or an outage condition with corresponding assigned time periods.

9. The method as claimed in claim 8,
wherein the electrolysis units are progressively switched on or off depending on the predicted supply power and/or a capacity and the state of charge of the storage device.
